(19) United States
(12) Patent Application Publication
(10) Pub. No.: US 2014/0266570 A1
(43) Pub. Date: Sep. 18, 2014

(54) SYSTEM AND METHOD FOR HAPTIC BASED INTERACTION

(71) Applicants: Anirudh Sharma, Delhi (IN); Krispian Caspar Lawrence, Swcunderabad (IN); Vinod Subramanian, Secunderabad (IN); Kunal Gupta, Secunderabad (IN)

(72) Inventors: Anirudh Sharma, Delhi (IN); Krispian Caspar Lawrence, Swcunderabad (IN); Vinod Subramanian, Secunderabad (IN); Kunal Gupta, Secunderabad (IN)

(21) Appl. No.: 13/794,858

(22) Filed: Mar. 12, 2013

(51) Int. Cl. G09B 21/00

(52) U.S. Cl. CPC G09B 21/003
USPC 340/4.12

(57) ABSTRACT

A haptic feedback based shoe including at least one microprocessor unit configured to control at least one operation of the shoe, at least one battery configured to provide a power supply voltage, and at least one Radio Frequency (RF) unit configured to communicate with at least one external electronic device using at least one wireless communication protocol. The shoe further includes at least one vibration motor configured to generate at least one pattern of vibration, at least one inertial motion unit (IMU), the at least one IMU further including at least one magnetometer configured to provide at least one reading indicative of orientation. The shoe further includes at least one camera configured to provide at least one image data to the at least one microprocessor unit, the at least one microprocessor unit further configured to detect at least one obstacle from the at least one image.

### TECHNICAL FIELD

The present disclosure relates to Human Computer Interaction, more specifically, to systems and methods for haptic based interaction.

### BACKGROUND

In today's digital age, there have been several advancements in the field of Human Computer Interaction. However, using the feet and foot based haptic interaction devices as a medium for human computer interaction remains relatively unexplored. In some situations, foot based haptic interaction devices can be very beneficial for individuals with a physical disability. For example, if a user suffers from visual impairment, performing daily activities such as, for example, navigation, orientation, and/or obstacle detection independently can become challenging. Currently available navigation systems for the visually challenged rely primarily on providing audio feedback. Because visually challenged individuals rely heavily on their sense of hearing, pure audio feedback can be a distraction. Furthermore, conventional navigation and interaction systems for visually challenged individuals are complex to use, obtrusive (bulky) and are also a burden to carry by the visually impaired people.

With respect to able bodied individuals, current interactive systems operate by relying primarily on Audio, visual, and hand based feedback. However, there exist several situations wherein relying on and/or providing feedback via the aforementioned senses may be distracting and/or non-intuitive.

Therefore, there is a need for a more efficient foot based haptic interaction system that is intuitive to use and non-obtrusive.

### SUMMARY

Consistent with some embodiments of the present disclosure, a haptic feedback based shoe may include at least one microprocessor unit configured to control at least one operation of the shoe, at least one battery configured to provide a power supply voltage, and at least one Radio Frequency (RF) unit configured to communicate with at least one external electronic device using at least one wireless communication protocol. The shoe further includes at least one vibration motor configured to generate at least one pattern of vibration, at least one inertial motion unit (IMU), the at least one IMU further including at least one magnetometer configured to provide at least one reading indicative of orientation.

In another embodiment, a system for human computer interaction using a pair of haptic shoes, may include at least one external device configured to communicate with a first shoe and a second shoe. The first shoe and the second shoe may each include at least one microprocessor unit configured to control at least one operation of the shoe, at least one battery configured to provide a power supply voltage, and at least one Radio Frequency (RF) unit configured to communicate with at least one external electronic device using at least one wireless communication protocol. The shoe further includes at least one vibration motor configured to generate at least one pattern of vibration, at least one inertial motion unit (IMU), the at least one IMU further including at least one magnetometer configured to provide at least one reading indicative of orientation.

In another embodiment, a haptic feedback based shoe may include at least one microprocessor unit configured to control at least one operation of the shoe, at least one battery configured to provide a power supply voltage, and at least one Radio Frequency (RF) unit configured to communicate with at least one external electronic device using at least one wireless communication protocol. The shoe further includes at least one vibration motor configured to generate at least one pattern of vibration, at least one inertial motion unit (IMU), the at least one IMU further including at least one magnetometer configured to provide at least one reading indicative of orientation. The shoe further includes at least one camera configured to provide at least one image data to the at least one microprocessor unit, the at least one microprocessor unit further configured to detect at least one obstacle from the at least one image.

Additional features and advantages of the invention will be set forth in part in the description which follows, and in part will be obvious from the description, or may be learned by practice of the invention. The features and advantages of the invention will be realized and attained by the elements and combinations particularly pointed out in the appended claims.

### BRIEF DESCRIPTION OF THE DRAWINGS

The accompanying drawings, which are incorporated in and constitute a part of this specification, illustrate embodiments disclosed herein, together with the description, serve to explain the principles of the disclosed embodiments.

FIG. 1a illustrates a block of an exemplary interaction system consistent with the disclosed embodiments.

FIG. 1b illustrates a high-level block diagram of an exemplary mobile unit consistent with the disclosed embodiments.

FIGS. 2a, 2b, and 2c are block diagrams illustrating a wearable unit consistent with the disclosed embodiments.

FIGS. 3a-3f are block diagrams illustrating an obstacle detection unit consistent with the disclosed embodiments.

FIGS. 4a-4d illustrate a haptic based wearable interaction system consistent with the disclosed embodiments.

FIGS. 5a-5h illustrate another haptic based wearable interaction system consistent with the disclosed embodiments.

FIGS. 6a-6f illustrate yet another haptic based wearable interaction system consistent with the disclosed embodiments.

FIGS. 7a and 7b are tables illustrating exemplary features of wearable interaction system consistent with the disclosed embodiments.

### DETAILED DESCRIPTION

In the following description and claims, the terms “coupled” and “connected,” along with their derivatives, may be used. It should be understood that these terms are not intended as synonyms for each other. Rather, in particular embodiments, “connected” and/or “coupled” may be used to indicate that two or more elements are in direct physical or electronic contact with each other. However, “coupled” may also mean that two or more elements are not in direct contact with each other, but yet still cooperate, communicate, and/or interact with each other.

FIG. 1 a illustrates an exemplary haptic interaction system 100 consistent with the disclosed embodiments. Haptic is a tactile feedback mechanism that takes advantage of the sense of touch by applying forces, vibrations, or motions. It should be understood that the various functional units depicted in the FIGS. 1-7, individually or in any combinations, may be implemented in hardware, in software executed on one or more hardware components (such as one or more processors, one or more application specific integrated circuits (ASIC's) or other such components), or in a combination of hardware and software.

As is shown in FIG. 1 a, system 100 can include a mobile unit (MU) 102 and at least one user wearable unit (WU) 104. For convenience, system 100 is shown as including two user wearable unit's WU 104 and WU 106. However, it should be understood that in practice there may be any number of wearable units, such as exemplary units WU (104 and 106), that can be included in system 100. Therefore, the present disclosure is not limited in the number of wearable units that may be included and/or supported by an haptic interaction system consistent with the disclosed embodiments.

Furthermore, the following figures and discussion describe a haptic based interaction system in context of a user wearable system, that is, a system that can be worn on one or more parts of a user's body. However, it should be understood that the various aspects of the system discussed below is not limited to a user wearable system but can be used in a non-wearable context.

In addition, the following figures and discussion describe a haptic based interaction system as including a mobile unit such as exemplary MU 102. However, it should be understood that in practice exemplary MU 102 can be either a fixed or a mobile external device. Therefore, the various aspects of the system discussed below is not limited for use with only mobile external device but can be used with fixed external devices as well.

As is further shown in FIG. 1 a, MU 102 can communicate wirelessly with WU 104 and WU 106 via antennas 108, 110, and 112, respectively. Though not depicted in FIG. 1a, it should also be understood that MU 102 and exemplary units WU 104 and WU 106 can be coupled together via a wired connection, and can further communicate with each other via a wireless and/or wired connection.

As will be discussed in detail below, MU 102 can communicate with WU's 104 and 106 to convey one or more commands and/or signals that can alert the user to perform and/or take one or more actions. Furthermore, WU's 104 and 106 can also be configured to send one or more commands and/or signals to MU 102, thereby controlling one or more function and/or operations of MU 102.

FIG. 1b illustrates a high-level block diagram of an exemplary mobile unit such as MU 102 consistent with the disclosed embodiments. In some embodiments, MU 102 can be for example, a smartphone, a cellphone, IPOD, IPAD, tablet device, laptop computer, TV, game console, or any such device that can be capable of communicating with WU's 104 and 106 via a wired and/or wireless communication protocol. As is shown in FIG. 1 b, MU 102 can include a user interface (UI) unit 116. For example, UI unit 116 can be a combination of one or more of a keypad, a touch screen, a Braille display, voice/speech input, or any such interface that can allow a user to interact with MU 102. MU 102 can also include a central processing unit (CPU) 114 and a memory 118. In some embodiments, a computer readable program can be loaded in memory 118 of MU 102, the computer readable program when executed can configure MU 102 to communicate with WU's 104 and 106 by sending one or more commands/signals and thereby enabling WU's 104 and 106 to perform one or more operations. Furthermore, the computer readable program code can also configure MU 102 to receive one or more commands and/or signals from WU 104 and/or WU 106.

MU 102 can also include a location unit (LU) 120 that is capable of computing geographical location based information. For example, LU 120 can include a global positioning system (GPS) receiver that can compute location based co-ordinates. In some embodiments, LU 120 can also be capable of performing Assisted GPS (AGPS) operations to compute geographical location information. In some embodiments, LU 120 can also include a Wi-Fi receiver and LU 120 can be further configured to compute indoor based location information. For example, in some embodiments, within an indoor facility such as, for example, shopping malls, hospitals, museums, etc., LU 120 can be configured to compute location information by triangulating signals received from one or more fixed Wi-Fi transmitters. The computed location information can be used in conjunction with building plan/floor plan/indoor map information etc., to compute location information within the indoor facility.

As further shown in FIG. 1 b, MU 102 can further include a Bluetooth unit 122. As will be discussed in detail below, MU 102 can be configured to communicate with exemplary WU's 104 and 106 via bluetooth unit 122. For convenience, FIG. 1 b depicts MU 102 as including a Bluetooth unit. However, it should be understood that in practice, exemplary MU 102 can include one or more units that are capable of implementing any wireless communication protocol for communicating with devices, such as exemplary units WU (104 and 106). Therefore, the present disclosure is not limited in the wireless communication protocols that may be included and/or supported by a mobile unit consistent with the disclosed embodiments.

FIG. 2a illustrates a high-level block diagram of an exemplary Wearable unit, such as WU 104 and WU 106, consistent with the disclosed embodiments. For convenience, the following figures and specification describe the operation of system 100 with respect to WU 104. However, it should be understood that WU 106 can have a similar structure and functionality as WU 104.

According to non limiting exemplary embodiments, Wearable unit 104 may include a microcontroller unit (MCU) 202 that can be coupled to a power unit 220. In some embodiments, Power unit 220 can further include one or more batteries such as, for example, a rechargeable lithium-polymer or lithium-ion battery, a solar cell, or any such device capable of providing electrical power required for the operation of MCU 202 and in turn WU 104. In some embodiments, Power unit 220 can further include a voltage regulator circuit (not shown in FIG. 2a) that can be configured to control a voltage supplied from a battery in PU 220 to one or more components in WU 104. In some embodiments, power unit 220 can also include a port for plugging in a wall charger to charge the elements of WU 104. In some embodiments, power unit 220 can include a port for interfacing WU 104 to a computer or an external electronic device, to allow for data transfer to/from WU 104 and the connected electronic device. In some embodiments, power unit 220 can also include circuitry that can enable the elements of the WU 104 to be charged through inductive charging also referred as wireless charging. In some embodiments, power unit 220 can be further coupled to an On/off switch 222 that can be configured to manually turn on and/or off WU 104. In some embodiments, switch 222 can also include a pressure sensitive switch. MCU 202 can be configured for processing signals and enabling communication between various elements of the WU 104 and in turn with MU 102.

WU 104 can also include a radio frequency (RF) unit 218 that can be coupled to MCU 202. RF unit 218 can include relevant hardware and/or software components that can allow WU 104 to communicate with MU 102. For example, WU 104 can communicate wirelessly with MU 102 via RF unit 218 by establishing a Bluetooth, infra-red, or any such wireless connection that can allow the transfer of data to/from MU 102 and MCU 202. Furthermore, in some embodiments WU 104 can also include a secondary RF unit 219. RF 219 can include a structure similar to RF 218 and can be configured to communicate with one or more additional navigational units. For example, in system 100, WU 104 and WU 106 can communicate with each other via secondary RF unit 219. Furthermore, in some embodiments, secondary RF unit 219 can be included as part of RF unit 218.

As is further shown in FIG. 2a, WU 104 can also include one or more Actuation Units (AU), such as exemplary AU's 204, 206, 208, and 210, coupled to MCU 202. For convenience, FIG. 2a depicts WU 104 as including four actuation units. However, it should be understood that in practice there may be any number of actuation units, such as exemplary units AU (210, 212, 214, and 216), included in WU 104. Therefore, the present disclosure is not limited in the number of actuation units that may be included and/or supported by a Wearable unit consisted with the disclosed embodiments.

Actuation units, such as exemplary AU's (210, 212, 214, and 216) can each be configured to generate one or more indicators (feedback). For example, exemplary AU's (210, 212, 214, and 216) can be configured to generate one or a combination of audio, video, and/or haptic feedback. In some embodiments, exemplary AU's (210, 212, 214, and 216) can be configured to generate haptic feedback such as a vibration. Furthermore, in some embodiments, exemplary AU's (210, 212, 214, and 216) can be configured to generate one or more vibration(s) of varying intensity and/or, frequency, and/or time duration. In some embodiments, exemplary AU's (210, 212, 214, and 216) can also be configured to generate one or more vibration(s) of different patterns, such as, for example continuous vibration, pulsed vibration, etc. In some embodiments, information/alerts/instructions to a user of exemplary system 100 can be conveyed via one or more of AU's (210, 212, 214, and 216) through one or more vibrations.

During regular operation of WU 104, AU's 204, 206, 208, 210 may be actuated on receiving a command and/or signal from MU 102. In addition, AU's 204, 206, 208, 210 may also be actuated by MCU 202. Based on the type of input provided by the user through User Interface 116, MU 102 can transmit one or more commands/signal to the AU's 204, 206, 208, 210 through via Bluetooth Unit 122 and RF unit 218.

FIG. 2b illustrates a high-level block diagram of another exemplary Wearable unit, such as WU 104 and WU 106, consistent with the disclosed embodiments. As shown in FIG. 2b, in some embodiments, WU 104 may also include an Inertial Motion Unit (IMU) 221 coupled to MCU 202. In some embodiments, IMU 221 can include individually or a combination of one or more of an accelerometer, gyroscope and magnetometer. The structures of the various units (accelerometers, gyroscopes, and/or magnetometers) that can be included in IMU 221 are well known by a person of ordinary skill.

In some embodiments, IMU 221 in WU 104 can be configured to compute and or detect information related to, for example, position, orientation, heading, gestures, motion, acceleration, velocity etc. The information gathered by IMU 221 can be further transmitted to MU 102 and various event based decision can be further made by MU 102. As discussed above, MU 102 can send various feedback (such as vibrations) via WU 104 and WU 106 to alert a user about a particular event and/or to instruct the user to perform a particular action. In some embodiments, MCU 202 in WU 104 can be configured to be configured to compute and or detect information related to, for example, position, orientation, heading, gestures, motion, acceleration, velocity etc., and MCU 202 can further generate one or more vibrations via exemplary AU's 204, 206, 208, and 210 to alert the user about a particular event and/or to instruct the user to perform a particular action.

In some embodiments, IMU 221 can be included as a part of MU 102, and readings from IMU 221 can be used be used by MU 102 to compute and/or detect information related to, for example, position, orientation, heading, gestures, motion, acceleration, velocity etc. In some embodiments, WU 104 can include a pressure sensitive sensor (PS) 223 such as a piezoelectric sensor. As will be discussed in detail below, WU 104 can be configured to be automatically turned on and/or off via PS 223.

FIG. 2c illustrates a high-level block diagram of another exemplary Wearable unit, such as WU 104 and WU 106, consistent with the disclosed embodiments. As is shown in FIG. 2C, in some embodiments, WU 104 can further include an Obstacle Detection Unit (ODU) 223 that can be coupled to MCU 202. As will be discussed in detail in FIGS. 3a-3f, ODU 223 can include various hardware and/or software and can be configured to detect and alert the user of the presence of one or more obstacles in their path. In some embodiments, ODU 223 can be a standalone unit (separate from WU 104) that can be coupled to WU 104 through either a wired or wireless connection via RF unit 218. In some embodiments, ODU 223 can be a standalone unit (separate from WU 104) that can be coupled to MU 102 through either a wired or wireless connection.

FIG. 3a illustrates a high-level block diagram of an exemplary Obstacle Detection Unit, such as ODU 223, consistent with the disclosed embodiments. As is shown in FIG. 3a, ODU 223 can include a microcontroller unit (MCU) 302. MCU 302 can be similar in structure to MCU 202 discussed with respect to FIGS. 2a-2c. It should be understood that in some embodiments, if ODU 223 is included as part of WU 104, MCU 302 can then be included in part or as a whole in MCU 202. That is, MCU 302 and MCU 202 can be one and the same.

As is further shown in FIG. 3a, MCU 302 can be further coupled to Ultrasonic sensors 304, 306 and 308, that can be configured via MCU 302 to transmit ultrasonic pulses of sound. The sound waves transmitted by each of sensors 304, 306, and 308, travel in a path (cone) as depicted in FIG. 3a as cone 301, 303, and 305, respective. Each of sensors 304, 306, and 308 can be further configured to give a distance measure of one or more obstacles that can lie within their respective cone. In some embodiments, by monitoring the data received from one or more of sensors 304, 306, and 308, MCU 302 can alert the user via one or more exemplary AU's 204, 206, 208, ad 210 (not shown in FIG. 3a) of the presence of one or more obstacles. For convenience, ODU 223 is shown as including three ultrasonic sensors. However, it should be understood that in practice there may be any number of ultrasonic sensors, such as exemplary sensors 304, 306, and 308 that can be included in ODU 223. Therefore, the present disclosure is not limited in the number of ultrasonic sensors that may be included and/or supported by a obstacle detection system consisted with the disclosed embodiments.

In some embodiments, by monitoring the data received from one or more of sensors 304, 306, and 308, MCU 302 can be further configured to compute a path that can enable the user to avoid the one or more detected obstacles. In this case, MCU 302 via one or more exemplary AU's 204, 206, 208, ad 210 (not shown in FIG. 3a) can guide the user along a path that can help him/her to avoid the one or more detected obstacles. In some embodiments, MCU 302 can be configured to transmit readings from sensors 304, 306, and 308 to MU 102. And MU 102 can be further configured to process the reading of sensors 304, 306, and 308, and alert the user to take appropriate action by transmitting commands/signals to WU 104 and/or WU 106.

FIG. 3b illustrates a high-level block diagram of another exemplary Obstacle Detection Unit, such as ODU 223, consistent with the disclosed embodiments. As shown in FIG. 3b, ODU 223 can include MCU 302 that is coupled to Image sensors 310, 311, and 312 and the illumination unit 309. Image sensors 310, 311, and 312 can have a similar structure and can be configured to generate scene information in the form of image data. In some embodiments, image sensors 310, 311, and 312 can be one or a combination of a camera, an infra-red camera, or any such sensor that can capture visual information. Illumination unit 309 can be any light source that can be capable of generating visible and/or infra-red light for illuminating a path to be processed by one or more of sensors 310, 311, and 312. For convenience, ODU 223 is shown as including three image sensors and one illumination unit. However, it should be understood that in practice there may be any number of image sensors and illumination units, such as exemplary image sensors 310, 311, and 312 and illumination unit 309 that can be included in ODU 223. Therefore, the present disclosure is not limited in the number of image sensors and/or illumination units that may be included and/or supported by a obstacle detection system consisted with the disclosed embodiments.

As is further shown in FIG. 3b, MCU 302 can be coupled to sensors 310, 311 and 312, to receive visual information. MCU 302 can be further configured to process data received from one or more of sensors 310, 311, and 312 to detect if one or more obstacles lie in the path ahead. In some embodiments, by monitoring and/or processing data received from one or more of sensors 310, 311, and 312, MCU 302 can alert the user via one or more exemplary AU's 204, 206, 208, ad 210 (not shown in FIG. 3b) of the presence of one or more obstacles.

In some embodiments, by monitoring the data received from one or more of sensors 310, 311, and 312, MCU 302 can be further configured to compute a path that can enable the user to avoid one or more detected obstacles. In this case, MCU 302 via one or more exemplary AU's 204, 206, 208, ad 210 (not shown in FIG. 3b) can guide the user along a path that can help him/her to avoid the one or more detected obstacles. In some embodiments, MCU 302 can be configured to transmit data from sensors 310, 311, and 312 to MU 102. And MU 102 can be further configured to process the data from one or more of sensors 310, 311, and 312, and alert the user to take appropriate action by transmitting commands/signals to WU 104 and/or WU 106.

FIG. 3c illustrates a high-level block diagram of another exemplary Obstacle Detection Unit, such as ODU 223, consistent with the disclosed embodiments. As shown in FIG. 3c, ODU 223 can include MCU 302 that is coupled to an Image sensor such as exemplary image sensor 310 and a structured light unit 313. For convenience, ODU 223 is shown as including one image sensors and one structured light unit. However, it should be understood that in practice there may be any number of image sensors and structured light units, such as exemplary image sensors 310 and structured light unit 313 that can be included in ODU 223. Therefore, the present disclosure is not limited in the number of image sensors and/or structured light units that may be included and/or supported by a obstacle detection system consisted with the disclosed embodiments.

Structured light unit 313 can be a light source that can project one or more light patterns, such as exemplary pattern 314 (shown in FIG. 3c). For example, structured light unit can be, without limitation, a laser, micro mirror and projector assembly, or any such unit that can be capable of projecting a light pattern on a surface. Structured light unit 313 can be further configured to project either visible light or infra-red light patterns. For convenience, structured light unit 313 is shown as projecting a rectangular grid pattern. However, it should be understood that in practice there may be any number and/or types of patterns, such as exemplary pattern 314 that can be projected by structured light unit 313. Therefore, the present disclosure is not limited in the number or style of pattern that can be projected by a structured light unit consistent with the disclosed embodiments.

Image sensors 310 can have a structure similar to that discussed with respect to FIG. 3b and can be configured to capture image data corresponding to the pattern projected by structured light unit 313. As is further shown in FIG. 3c, MCU 302 can be coupled to sensor 310 and structured light unit 313 to receive visual information from sensor 310. MCU 302 can be further configured to process data received from sensors 310 to detect if one or more obstacles lie in a path ahead. In some embodiments, obstacles can be detected by capturing (via sensor 310) image data corresponding to a light pattern (such as exemplary pattern 314) projected by structured light unit 313 and comparing the captured image data with predetermined image data calculated during a calibration process. The differences between the captured image data and the predetermined data can be used to detect the presence of one or more obstacles.

In some embodiments, by monitoring and/or processing data received from sensor 310, MCU 302 can alert the user via one or more exemplary AU's 204, 206, 208, ad 210 (not shown in FIG. 3c) of the presence of one or more obstacles. In some embodiments, by monitoring the data received from sensor 310, MCU 302 can be further configured to compute a path that can enable the user to avoid one or more detected obstacles. In this case, MCU 302 via one or more exemplary AU's 204, 206, 208, ad 210 (not shown in FIG. 3c) can guide the user along a path that can help him/her to avoid the one or more detected obstacles. In some embodiments, MCU 302 can be configured to transmit data from sensor 310 to MU 102. And MU 102 can be further configured to process the data from sensor 310, and alert the user to take appropriate action by transmitting one or more commands/signals to WU 104 and/or WU 106.

Referring to FIG. 3d, in some embodiments ODU 223 discussed with respect to FIG. 3c can also include Illumination Unit 309. Illumination unit 309 can be similar in structure to that discussed with respect to FIG. 3b.

FIG. 3e illustrates a high-level block diagram of another exemplary Obstacle Detection Unit, such as ODU 223, consistent with the disclosed embodiments. As shown in FIG. 3e, ODU 223 can include MCU 302 that can be coupled to ultrasonic sensors 304 and 306, Image sensor 310, and illumination unit 309. Sensors 304, 306, 310 and illumination unit 309 are similar in structure to those discussed with respect to FIGS. 3a-3d. For convenience, ODU 223 is shown as including two ultrasonic sensors, one image sensor and one illumination unit. However, it should be understood that in practice there may be any number of ultrasonic sensors, image sensors and illumination units, such as exemplary ultrasonic sensors 304 and 306, image sensor 310 and illumination unit 309, that can be included in ODU 223. Therefore, the present disclosure is not limited in the number of ultrasonic sensors, image sensors and/or illumination units that may be included and/or supported by an obstacle detection system consistent with the disclosed embodiments.

In a manner similar to that discussed with respect to FIG. 3a, MCU 302 can be configured to receive a distance measure of one or more obstacles that can lie within the cones of sensors 304 and 306. Furthermore, in a manner similar to that discussed with respect to FIG. 3b, MCU 302 can be configured to also to receive visual information from image sensor 310. MCU 302 can be further configured to process data received from one or more of sensors 304, 306, and 310 to detect if one or more obstacles lie in a path ahead. In some embodiments, by monitoring and/or processing data received from one or more of sensors 304, 306, and 310, MCU 302 can alert the user via one or more exemplary AU's 204, 206, 208, ad 210 (not shown in FIG. 3e) of the presence of one or more obstacles.

In some embodiments, by monitoring the data received from one or more of sensors 304, 306, and 310, MCU 302 can be further configured to compute a path that can enable the user to avoid one or more detected obstacles. In this case, MCU 302 via one or more exemplary AU's 204, 206, 208, ad 210 (not shown in FIG. 3e) can guide the user along a path that can help him/her to avoid the one or more detected obstacles. In some embodiments, MCU 302 can be configured to transmit data received from sensors 304, 306, and 310 to MU 102. And MU 102 can be further configured to process the data from one or more of sensors 304,306, and 310 and alert the user to take appropriate action(s) by transmitting one or more commands/signals to WU 104 and/or WU 106. In some embodiments, information received from ultrasonic sensors 304 and 306 can be used to detect obstacles between knee and head height of a user, while information received from image sensor 310 can be used to detect obstacles below knee height and above head height of a user.

FIG. 3f illustrates a high-level block diagram of another exemplary Obstacle Detection Unit, such as ODU 223, consistent with the disclosed embodiments. In a manner similar to that discussed with respect to FIG. 3e, ODU 223 can also include a structured light unit 313 that is similar in structure to that discussed with respect to FIG. 3c. For convenience, ODU 223 is shown as including one structured light unit. However, it should be understood that in practice there may be any number of structured light units, such as exemplary structured light unit 313 that can be included in ODU 223. Therefore, the present disclosure is not limited in the number of structured light units that may be included and/or supported by an obstacle detection system consistent with the disclosed embodiments.

In a manner similar to that discussed with respect to FIG. 3a, MCU 302 can be configured to receive a distance measure of one or more obstacles that can lie within the cones of sensors 304 and 306. Furthermore, in a manner similar to that discussed with respect to FIGS. 3b and 3c, MCU 302 can be configured to receive visual information from image sensor 310 that can also include captured structured light pattern data. MCU 302 can be further configured to process data received from one or more of sensors 304, 306, and 310 to detect if one or more obstacles lie in a path ahead. In some embodiments, by monitoring and/or processing data received from one or more of sensors 304, 306, and 310, MCU 302 can alert the user via one or more exemplary AU's 204, 206, 208, ad 210 (not shown in FIG. 3e) of the presence of one or more obstacles.

In some embodiments, by monitoring the data received from one or more of sensors 304, 306, and 310, MCU 302 can be further configured to compute a path that can enable the user to avoid one or more detected obstacles. In this case, MCU 302 via one or more exemplary AU's 204, 206, 208, ad 210 (not shown in FIG. 3e) can guide the user along a path that can help him/her to avoid the one or more detected obstacles. In some embodiments, MCU 302 can be configured to transmit data received from sensors 304, 306, and 310 to MU 102. And MU 102 can be further configured to process the data from one or more of sensors 304,306, and 310 and alert the user to take appropriate action(s) by transmitting one or more commands/signals to WU 104 and/or WU 106. In some embodiments, information received from ultrasonic sensors 304 and 306 can be used to detect obstacles between knee and head height of a user, while information received from image sensor 310 can be used to detect obstacles below knee height and above head height of a user, and structured light pattern information corresponding to structured light unit 313 and received via image sensor 310 can be used to detect surface features of the path ahead.

FIG. 4a illustrates an exemplary Wearable unit that can be embedded in a wearable object such as a shoe insole 400. In some embodiments, insole 400 can operate in a manner similar to WU 104 discussed with respect to FIG. 2a. As shown in FIG. 4a, insole 400 can include a Microcontroller unit (MCU) 402 coupled to a power unit (PU) 420 and a RF unit 418. MCU 402 can be further coupled to a vibration motor 404. In some embodiments, MCU 402, power unit 420, RF unit 418, and vibrator 404 can have similar structure and functionality as MCU 202, power unit 220, RF unit 218, and AU 204, respectively, discussed with respect to FIG. 2a. For convenience, FIG. 4a depicts insole 400 as including one actuation unit. However, it should be understood that in practice there may be any number of actuation units, such as exemplary vibrator 404, included in insole 400. Therefore, the present disclosure is not limited in the number of actuation units that may be included and/or supported by an insole consistent with the disclosed embodiments. As is further shown in FIG. 4a, Insole 400 can also include an IMU 421 coupled to MCU 402. In some embodiments, IMU 421 can have similar structure and functionality as IMU 221, discussed with respect to FIG. 2b. As is further shown in FIG. 4a, in some embodiments, power unit 420 can be coupled to an On/off switch 422 that can be configured to manually turn on and/or off insole 400. Furthermore, in some embodiments, switch 222 can also be coupled to a pressure sensitive sensor (PS) 423 (such as a piezoelectric sensor). PS 423 can be configured to provide one or more readings that can correspond to the force exerted on PS 423. As discussed above, in some embodiments, PS 423 can also be used to automatically turn ON/OFF insole 400. Furthermore, in some embodiments, PS 423 can also be used to detect various gesture events such as footsteps.

In some embodiments, the various units included in shoe 400 can be placed inside a metal or plastic enclosure (not shown in FIG. 4a). The enclosure can be designed in a manner that can protect the various units/components from impact due to the weight of a user or normal wear and tear.

FIG. 4b is an illustration of how insole 400 can be inserted into a wearable medium such as a shoe. For convenience, FIG. 4b depicts insole 400 as being inserted in a shoe. However, it must be understood that in practice insole 400 can be inserted and used with any type of footwear, including without limitation, sandals, slippers, flip-flops, etc.

FIG. 4c illustrates an exemplary Wearable Interaction System 400A consistent with the disclosed embodiments. As shown in FIG. 4c, system 400A can include two insoles 400L (intended to be worn on the left foot) and 400R (intended to be worn on the right foot). Insoles 400L and 400R are similar in structure and functionality to insole 400 discussed with respect to FIG. 4a.

As is further shown in FIG. 4c, insoles 400L and 400R can further communicate with a mobile unit such as exemplary MU 102. For convenience, FIG. 4c depicts MU 102 as being a mobile phone. However, it should be understood that in practice, MU 102 can be for example, a smartphone, a cellphone, IPOD, IPAD, tablet device, laptop computer, TV, game console, or any such device that can be capable of communicating with insoles's 400L and 400R via a wired and/or wireless communication protocol. In some embodiments, MU 102 can include computer readable program code which when executed by a processor in MU 102 can configure MU 102 to communicate with insoles 400L and 400R to provide navigation and/or orientation information to a user. During regular operation of system 400A, a user can interact with MU 102 via user interface 116 (not shown in FIG. 4c). For example, a user may set a desired destination he/she intends to travel too. MU 102 can then via location unit 120 (not shown in FIG. 4c) and map data stored in memory 118 (not shown in FIG. 4c) compute a route from the users current location to the desired destination set by the user. In some embodiments, MU 102 can be configured to retrieve map data and/or route information via a data connection or a wi-fi connection enabled in MU 102.

In some embodiments, the user can receive feedback related to route information from MU 102 through one or more vibrations in insole 400L and/or insole 400R

In an exemplary embodiment, system 400A can be used to assist visually challenged individuals to navigate to a desired destination in a safe and independent manner. During normal operation of system 400A, a user can interact with MU 102 and set a desired destination as discussed above.

In some embodiments, switch 422 included in insole 400L and 400R, respectively, can be coupled to pressure sensitive switch. In some embodiments, switch 422 itself can be a pressure sensitive switch. In some embodiments, insole 400L and 400R can automatically turn ON when a user wears the insoles. Furthermore, when the user interacts with MU 102, a bluetooth connection can be automatically established between insole 400L, insole 400R, and MU 102. In addition, a small vibration can be felt in both insole 400L and insole 400R, to indicate to the user that the system 400A is connected and ready for use.

Once the computer readable program code on MU 102 has been initialized, location information regarding the user's current location is received from location unit 120 of MU 102. As was discussed with respect to FIG. 2a, location unit 120 can include a GPS receiver. In some embodiments, if a user of system 400A is indoors, or if a GPS signal is unavailable, MU 102 can also be configured to receive location information using a combination of one or more methods including Assisted-GPS (AGPS) i.e triangulating MU 102's current location by using data received between various cell-towers, and/or using a wi-fi network to calculate location information.

Once a desired destination has been set by a user, MU 102 can compute a route from the user's current location to the set destination. The user can then place the MU 102 back in his or her pocket or bag, and start walking. Direction information pertaining to the calculated route is communicated to the user via one or more vibrations in Insole 400L and/or Insole 400R. For example, if the user has to take a left, he or she will receive a vibration in insole 400L, and if the user has to take a right, he or she will receive a vibration in insole 400R. Furthermore, through different patterns of vibrations, different information can be conveyed to the user. For example, if the user has to take a left turn, 20 meters before the turn the user can receive a 250 millisecond (ms) long vibration in insole 400L, 10 meters before the turn the user can receive a 500 ms vibration in insole 400L, and at the exact point of the turn, the user can receive a 1 second vibration in insole 400L. Similarly, if the user has to take a right turn, a similar procedure can be followed with respect to insole 400R. For convenience, the above description uses vibrations of 250 ms, 500 ms, and 1 second duration at 20 meters, 10 meters, and at the point of the turn, respectively. It should be understood that in practice, vibrations of any pattern and/or duration can be used to convey feedback to a user. As will be discussed with respect to FIGS. 7a and 7b below, a user can have the option to personalize the operation of system 400A including without limitation the vibration patterns, intensity, and/or duration. In this manner, direction as well as distance information can be communicated to the user through vibration feedback. In some embodiments, system 400A can also be configured to support multi-modal navigation including travel by a car, taxi, and/or public transport. For example, if a user of system 400A sets a destination that requires travel by public transport such as a bus, system 400A will for example, first navigate the user to the closet bus-stop by conveying directional information through a pattern of vibrations as discussed above. Once the user has reached the bus-stop, MU 102 can be configured to inform the user (via audio) of the bus to be boarded and the expected arrival time of the bus. In some embodiments, insole 400L and/or insole 400R can be configured to give a vibration pattern (identifiable by the user) to alert the user that MU 102 may have an audio alert. Once the user is on the bus, the user can receive an indication through a pattern of vibrations in insole 400L and/or insole 400R, as to when to get down from the bus. Once the user is out of the bus, system 400A can continue to navigate the user to the set destination by conveying directional information through a pattern of vibrations as discussed above. In some embodiments, system 400A can be configured to create custom maps of certain routes and/or add custom paths to the map data stored locally on MU 102. This feature can be used by users who have a favorite short-cut (bypass route) which is not mapped or for users who live in remote areas where smaller streets are not mapped. MU 102 can be configured to interact with insole 400L and 400R to create a custom path. For example, during navigation, a user can interact with MU 102 to add a short-cut or a bypass (such as a walk through a neighborhood park) that can reduce his or her travel time to a set destination. When the user is about to make a detour from the route calculated by MU 102, he or she can press (or speak) a button on MU 102 to initiate the custom path creation procedure. MU 102 can record location information (via location unit 120) along the path travelled by the user. In some embodiments, MU 102 can be configured to periodically record one or more GPS coordinate (latitude and longitude) values and digital compass values along the custom path. When the user has completed the detour and is back on a mapped street, he or she can press (or speak) the same or a different button on MU 102. MU 102 can then be configured to process the recorded location information along the custom path and MU 102 can be further configured to update the users map data locally stored on MU 102 to include the custom route. For a given short-cut, this process needs to be done only once. The next time the user sets a destination that can involve navigating in the same vicinity, the newly added shortcut can be automatically checked while computing a route.

In some embodiments, during navigation, if a user makes a detour to a location that is not included in the map data, he or she can be automatically queried by MU 102 (using vibrations) if the detour should be added as a custom route. If the user agrees, the detour will be automatically added to the locally stored map data.

In some embodiments, a user can start and/or stop the custom path creation procedure without physically interacting with MU 102. As will be discussed in detail later, the user can also start and/or stop the custom map/path creation procedure by MU 102 by executing a foot based gesture through one or more of insole 400L and/or insole 400R.

In some embodiments, system 400A can be configured to provide orientation assistance to a user. That is, system 400A can assist a user to point (head/face) in a correct direction (north, south, east, west, etc.). As was discussed with respect to FIG. 2b, IMU 421 (included in Insole 400L and 400R) can further include one or more of a 3-axis accelerometer, a gyroscope, and/or magnetometer (digital compass). MCU in both insole 400R and 400L can be configured to use corresponding magnetometer readings to compute the current heading of a user. In this way, if the intended or desired heading is known, the difference between the current heading and intended heading is calculated and a user can be pointed (oriented) in the right direction through a different pattern of vibrations. In some embodiments, the magnetometer can be configured to give a reading between 0 to 360 degrees with 0 degrees corresponding to magnetic North.

For example, during navigation, when a route to be taken by the user is computed, MU 102 can also be configured to compute a desired heading at each turn/direction in the route from the map data. Therefore, when a user is ready to navigate, the first feedback he or she can receive can be indicative of orientation. For example, if the current heading of a user is in the “North” direction, and the calculated route requires the user to be headed in the east direction, the user can receive a vibration pattern (such as, for example a continuous pulsed vibration) on insole 400R. Upon receiving this pattern of vibration, the user while standing in the same position can rotate towards his or her right. When the user is oriented in the correct direction (“East” in case of the example above), the vibration stops. Thus, the user can be alerted that he or she is oriented in the right direction. In some embodiments, system 400A can be configured to check for orientation readings in real-time. That is, during navigation to a set destination, if a user is heading off-course, an orientation correction mechanism can be automatically triggered and the user's orientation can be corrected by vibration patterns in insole 400L and/or 400R, as discussed above.

In some embodiments, orientation assistance can also be helpful in known indoor as well as outdoor locations. For example, while navigating to/from or within known locations, a user may not require direction information and may only require orientation information. In this case, the user can interact with MU 102 and request to be oriented in a particular direction.

In some embodiments, a user can request for orientation correction and/or request to be pointed in a particular direction without interacting with MU 102. As will be discussed in detail later, the user can also request for orientation correction without interacting with MU 102 by executing a foot based gesture through one or more of insole 400L and/or insole 400R. Furthermore, in some embodiments, the orientation procedures discussed above can be performed by any one of insole 400L or insole 400R.

In some embodiments, system 400A can be used to assist a user with indoor Navigation around locations such as, for example, homes, offices, malls, hospitals, etc. In manner similar to the custom map/path creation procedure discussed above, system 400A can also be configured to generate and save custom maps of indoor locations.

As was discussed above, insole 400L and 400R can each include one or more of an accelerometer, gyroscope and a magnetometer (digital compass) included as part of IMU 421. When a custom map creation procedure is requested and/or executed by a user for indoor map creation, MCU 402 in each of insole 400L and 400R can be configured to process corresponding readings from one or more of the accelerometer, gyroscope, and digital compass. MCU 402 in each of insole 400L and 400R can be further configured to transmit the processed magnetometer, accelerometer, and/or gyroscope data to MU 102. As will be discussed below, MU 102 can be configured to receive magnetometer, accelerometer, and/or gyroscope data from insoles 400L and 400R, and in turn generate an indoor map.

Every motion/gesture made by a user's foot/feet (whether it's taking a step forward or backward, or climbing up or down stairs, etc.) can have a specific pattern of accelerometer and/or the gyroscope readings. Insoles 400L and 400R can be configured to detect and identify various motions and/or gestures made by a user by processing the readings received from the accelerometer, magnetometer, and/or gyroscope. For example, in some embodiments, insoles 400L and 400R can use accelerometer reading (in IMU 421) to detect steps made/taken by a person, and can use gyroscope readings to compute a distance covered by the user in each corresponding step. Furthermore, insoles 400R and 400L can use magnetometer readings to further get a direction of travel in each step. In this way, by computing the distance and direction travelled by a user, an indoor map can be created by system 400A for any location. As will be discussed in detail later, the user can also start and/or stop the custom map/path creation procedure by MU 102 by executing a foot based gesture through one or more of insole 400L and/or insole 400R.

For an example, let us assume that a user of system 400A wishes to create an indoor map of a local hospital. For convenience, the discussion below explains the indoor map creation process with respect to a hospital. However, it should be understood that in practice the procedure below can be used to create a map for any indoor as well as outdoor location. To begin, the user can initiate the custom map creation procedure either by interacting with MU 102 or by one or more foot based gestures. It should be understood that this procedure needs to be done only once and the map created is automatically updated to the map data stored locally on MU 102. Furthermore, when the custom map creation procedure is initiated, based on GPS location information (from location unit 120 included in MU 102), MU 102 can automatically identify if the map to be created pertains to an indoor location and can automatically tag the map to the corresponding outdoor GPS location.

For example a user can start the indoor custom map creation procedure at the entrance of the building. The user can enter a tag (such as “Entrance”) via text or voice in the Le Chal app. The user can then start walking to a desired destination with the building. Each turn made by the user (and detected by the magnetometer in insole 400L and/or 400R) can be marked as a node, and a distance between each node can be calculated based on the accelerometer and/or gyroscope readings from IMU 421. In addition, all points of interest along a path can be tagged (such as “Entrance”, “Lobby,” “Doctor's office” etc.) by the user via text or voice in MU 102. Once the custom map creation procedure is complete, MU 102 can be configured to implement an algorithm that can use graph theory and converts the various nodes and points of interest into a connected graph (indoor map). Furthermore, based on GPS location information, MU 102 can be configured to automatically identify the indoor map as pertaining to an outdoor location and automatically tags the map to the corresponding outdoor GPS location. Therefore, the next time the user intends to travel to the above mentioned indoor location, he or she can have the option to set any location (node) inside the hospital (for example his/her doctor's office) as a destination. Furthermore, the above referenced indoor map creation procedure needs to be done only once and the map created is automatically updated to the map database stored locally on MU 102. In some embodiments, all the custom map data (indoor and/or outdoor) can be transmitted by MU 102 (via a data connection) to a central server (not shown in FIG. 4c). The central server can then make the data received from each user available to all users of system 400A. Furthermore, in some embodiments, the indoor and/or outdoor custom map creation procedures can be performed by MU 102 and any one of insole 400L or insole 400R.

In some embodiments, system 400A can be designed to be used as an interaction device. As was discussed earlier, IMU 421 can be used to detect various foot-based gestures. Furthermore, MU 102 can be configured to enable a user to save various gestures and then assign each of the saved gestures to perform one or more actions. Once a particular gesture has been assigned, a user can interact with MU 102 or Insole 400L and/or 400R through gestures. It should be understood that there are no restrictions on the number of gestures that can be saved and/or assigned by system 400A.

As discussed above, in some embodiments, insole 400L and/or 400R can also be connected to one or more other external electronic devices such as TV's, computers, laptop's, game consoles, mobile phones, ipad, tablets, or any such device that can be configured to communicate with insoles 400L and/or 400R through a wired and/or wireless communication via corresponding RF units 418. In some embodiments, insole 400L and/or 400R can be discovered as a Bluetooth device and can be connected via Bluetooth to any Bluetooth enabled electronic device. In some embodiments, insole 400L and/or 400R can be to a compatible electronic device via any radio frequency based communication protocol. Furthermore, in a manner similar to that discussed above a user wearing insole 400L and 400R can interact, communicate, and/or control any electronic device (connected to insoles 400L and 400R) through one or more gestures. Furthermore, all input and/or output feedback between insole 400L, insole 400R and the one or more connected electronic device(s) can be via haptics, such as, for example, one or more vibrations.

FIG. 4d illustrates another exemplary Wearable Interaction System 400B consistent with the disclosed embodiments. As shown in FIG. 4d, system 400B can include two insoles 400L (intended to be worn on the left foot) and 400R (intended to be worn on the right foot). Insoles 400L and 400R are similar in structure and functionality to insoles 400L and discussed with respect to FIG. 4c.

FIG. 5a illustrates another exemplary Wearable unit that can be embedded in a wearable object such as a shoe 500. As shown in FIG. 5a, the various units included in shoe 500 can be embedded within the sole of shoe 500. For convenience, the following figures and discussion describe the various units of a shoe consistent with the disclosed embodiments as being embedded in the sole of the shoe. However, it should be understood that in practice the various units can be included in any part/area of the shoe. Therefore, the present disclosure is not limited in the location of the various units included in a shoe consistent with the disclosed embodiments. The various units/components included in shoe 500 are similar in structure and functionality to the various units included in insole 400 as discussed with respect to FIG. 4a. Furthermore, the operation of shoe 500 can be identical to the operation of insole 400, as discussed with respect to FIG. 4a. For convenience, FIG. 5a depicts shoe 500 as including one actuation unit. However, it should be understood that in practice there may be any number of actuation units, such as exemplary vibrator 404, included in shoe 500. Therefore, the present disclosure is not limited in the number of actuation units that may be included and/or supported by a shoe consistent with the disclosed embodiments.

FIG. 5b illustrates another exemplary Wearable Interaction System 500A consistent with the disclosed embodiments. As shown in FIG. 5b, system 500A can include two shoes 500L (intended to be worn on the left foot) and 500R (intended to be worn on the right foot). As is shown in FIG. 5b, the various units included in shoe 500L and 500R can be embedded within the sole of shoe 500L and 500R, respectively. The various units/components included in shoe 500L and 500R are similar in structure and functionality to the various units included in insoles 400L and 400R as discussed with respect to FIG. 4c. Furthermore, the operation of shoe 500L and 500R can be identical to the operation of insole 400L and insole 400R, respectively, as discussed with respect to FIG. 4c.

FIG. 5c illustrates another exemplary Wearable Interaction System 500B consistent with the disclosed embodiments. As shown in FIG. 5c, system 500B can include two shoes 500L (intended to be worn on the left foot) and 500R (intended to be worn on the right foot). As is shown in FIG. 5c, the various units included in shoe 500L and 500R can be embedded within the sole of shoe 500L and 500R, respectively. The various units/components included in shoe 500L and 500R are similar in structure and functionality to the various units included in insoles 400L and 400R as discussed with respect to FIG. 4d. Furthermore, the operation of shoe 500L and 500R can be identical to the operation of insole 400L and insole 400R, respectively, as discussed with respect to FIG. 4d.

FIG. 5d illustrates another exemplary Wearable unit that can be embedded in a wearable object such as a shoe 500. As shown in FIG. 5d, in some embodiments, the various units included in shoe 500 can each be included inside a metal or plastic enclosure 501. As is further shown in FIG. 5d, shoe 500 can include an opening 503. Furthermore, opening 503 can be designed in a manner such that enclosure 501 can be securely fit into shoe 500. In addition, opening 503 can also be designed in a manner that can allow a user to use shoe 500 as a regular pair of shoes (without the need of inserting enclosure 501). Furthermore, the operation of shoe 500 can be identical to the operation of insole 400, as discussed with respect to FIG. 4a. For convenience, FIG. 5a depicts shoe 500 as including one actuation unit. However, it should be understood that in practice there may be any number of actuation units, such as exemplary vibrator 404, included in shoe 500. Therefore, the present disclosure is not limited in the number of actuation units that may be included and/or supported by a shoe consistent with the disclosed embodiments.

FIG. 5e illustrates another exemplary Wearable Interaction System 500C consistent with the disclosed embodiments. As shown in FIG. 5e, system 500C can include two shoes 500L (intended to be worn on the left foot) and 500R (intended to be worn on the right foot).

As shown in FIG. 5e, in some embodiments, the various units included in shoe 500L and 500R can each be included inside a metal or plastic enclosure 501. As is further shown in FIG. 5d, each of shoe 500L and 500R can include an opening 503. Furthermore, opening 503 can be designed in a manner such that enclosure 501 can be securely fit into shoe 500L and/or 500R. In addition, opening 503 can also be designed in a manner that can allow a user to use shoes 500L and 500R as a regular pair of shoes (without the need of inserting enclosure 501). For convenience, FIG. 5d depicts shoes 500L and 500R as each including an opening on the side. However, it should be understood that in practice there may be any number of openings, such as exemplary opening 503 that can included in any location in shoe 500L and/or 500R. Therefore, the present disclosure is not limited in the number or location of an opening that may be included and/or supported by a shoe consistent with the disclosed embodiments.

In some embodiments, enclosure 501 can be designed in a manner that can protect the various units/components from impact due to the weight of a user or due to normal wear and tear. In this manner, a user can use any pair of shoes that can include a compatible opening such as exemplary opening 503 that can allow enclosure 501 to be inserted into.

The various units/components included in shoe 500L and 500R are similar in structure and functionality to the various units included in insoles 400L and 400R as discussed with respect to FIG. 4c. Furthermore, the operation of shoe 500L and 500R can be identical to the operation of insole 400L and insole 400R, respectively, as discussed with respect to FIG. 4c.

FIG. 5f illustrates another exemplary Wearable Interaction System 500D consistent with the disclosed embodiments. As shown in FIG. 5e, system 500D can include two shoes 500L (intended to be worn on the left foot) and 500R (intended to be worn on the right foot).

As shown in FIG. 5f, in some embodiments, the various units included in shoe 500L and 500R can each be included inside a metal or plastic enclosure 501. As is further shown in FIG. 5f, each of shoe 500L and 500R can include an opening 503. Opening 503 and enclosure 501 can be similar in structure and functionality to that discussed with respect to FIG. 5e.

The various units/components included in shoe 500L and 500R are similar in structure and functionality to the various units included in insoles 400L and 400R as discussed with respect to FIG. 4d. Furthermore, the operation of shoe 500L and 500R can be identical to the operation of insole 400L and insole 400R, respectively, as discussed with respect to FIG. 4d.

FIG. 5g illustrates another exemplary Wearable Interaction System 500E consistent with the disclosed embodiments. As shown in FIG. 5g, system 500E can include two shoes 500L (intended to be worn on the left foot) and 500R (intended to be worn on the right foot).

As shown in FIG. 5g, in some embodiments, the actuation units such as vibrator 404 can be embedded in the sole of each of shoe 500L and 500R, respectively. As is further shown in FIG. 5g, the remaining units included in shoe 500L and 500R can each be included inside a metal or plastic enclosure 501. As is further shown in FIG. 5g, each of shoe 500L and 500R can include an opening 503. Opening 503 and enclosure 501 can be similar in structure and functionality to that discussed with respect to FIG. 5e.

The various units/components included in shoe 500L and 500R are similar in structure and functionality to the various units included in insoles 400L and 400R as discussed with respect to FIG. 4c. Furthermore, the operation of shoe 500L and 500R can be identical to the operation of insole 400L and insole 400R, respectively, as discussed with respect to FIG. 4c.

FIG. 5h illustrates another exemplary Wearable Interaction System 500F consistent with the disclosed embodiments. As shown in FIG. 5h, system 500F can include two shoes 500L (intended to be worn on the left foot) and 500R (intended to be worn on the right foot).

As shown in FIG. 5h, in some embodiments, the actuation unit such as vibrator 404 can be embedded in the sole of each of shoe 500L and 500R, respectively. As is further shown in FIG. 5h, the remaining units included in shoe 500L and 500R can each be included inside a metal or plastic enclosure 501. As is further shown in FIG. 5h, each of shoe 500L and 500R can include an opening 503. Opening 503 and enclosure 501 can be similar in structure and functionality to that discussed with respect to FIG. 5e.

The various units/components included in shoe 500L and 500R are similar in structure and functionality to the various units included in insoles 400L and 400R as discussed with respect to FIG. 4d. Furthermore, the operation of shoe 500L and 500R can be identical to the operation of insole 400L and insole 400R, respectively, as discussed with respect to FIG. 4d.

FIG. 6a illustrates an exemplary Wearable unit that can be embedded in a wearable object such as a shoe 600. As shown in FIG. 6a, shoe 600 can include a Microcontroller unit (MCU) 402 coupled to a power unit 420 and a RF unit 418. MCU 402 can be further coupled to an Actuator unit such as vibrator 404. As is further shown in FIG. 6a, shoe 600 can also include an IMU 421 coupled to MCU 402. In some embodiments, MCU 402, power unit 420, RF unit 418, vibrator 404, and IMU 421 can have a similar structure and functionality as discussed with respect to FIG. 4a.

For convenience, FIG. 6a depicts shoe 600 as including one actuation unit. However, it should be understood that in practice there may be any number of actuation units, such as exemplary vibrator 404 included in shoe 600. Therefore, the present disclosure is not limited in the number of actuation units that may be included and/or supported by a shoe consistent with the disclosed embodiments.

As is further shown in FIG. 6a, shoe 600 can further include two ultrasonic sensors (Sonar) 624 and 626 coupled to MCU 402. Sonar sensors 624 and 626 can be similar in structure and functionality as sensors 304 and 306 discussed with respect to FIG. 3a. Furthermore, sensors 624 and 626 can have cones 625 and 627, respectively. MCU 402 can be further coupled to an image sensor such as camera (Cam) 628. Cam 628 can be similar in structure and functionality as image sensor 310 discussed with respect to FIGS. 3b-3f. In some embodiments, shoe 600 can also include an illumination unit (ILU) 630 that can be coupled to MCU 402. Illumination unit 630 can be similar in structure and functionality as illumination unit 309 discussed with respect to FIGS. 3b-3f. In some embodiments, shoe 600 can also include a structured light projection unit (SLP) 632 coupled to MCU 402. SLP 632 can be similar in structure and functionality as SLP 313 discussed with respect to FIGS. 3c, 3d, and 3f, and can project a light pattern 633.

Sonar sensors 624 and 626, Cam 628, illumination unit 630, and SLP 632 together with MCU 402 operate as an obstacle detection system and operate in a manner similar to that discussed with respect to FIGS. 3a-3f. SLP 632 can be similar in structure and functionality as SLP 313 discussed with respect to FIGS. 3c, 3d, and 3f.

FIG. 6b illustrates an exemplary Wearable Interaction System 600A consistent with the disclosed embodiments. As shown in FIG. 6b, system 600A can include two shoes 600L (intended to be worn on the left foot) and 600R (intended to be worn on the right foot). Shoes 600L and 600R are similar in structure and functionality to shoe 600 discussed with respect to FIG. 6a.

As is further shown in FIG. 6b, shoes 600L and 600R can further communicate with a mobile unit such as exemplary MU 102. In some mebodiments, MU 102 can include computer readable program code which when executed by a processor in MU 102 can configure MU 102 to communicate with shoes 600L and 600R to provide functionality including but not limited to outdoor and indoor navigation, orientation, and interaction. The navigation, orientation, and interaction functionality provided by shoes 600L and 600R are similar to insoles 400L and 400R discussed with respect to FIGS. 4a-4d.

In addition to the above mentioned functionality, in some embodiments, system 600A can also be configured to detect one or more obstacles of different types and sizes that can hinder the safe passage of a user. As was discussed above, system 600A can detect one or more obstacles in a manner similar to that discussed with respect to ODU 223 in FIG. 3f.

Once an obstacle is detected by shoe 600L and/or 600R, the user can be alerted about the presence of an obstacle through a pattern of vibrations (different from direction and/or orientation information). In some embodiments, shoes 600L and/or 600R can be configured to alert the user about the existence of an obstacle in two possible ways (modes). In a first mode (known as avoidance mode), if an obstacle is detected, shoes 600L and/or 600R can give the user a pattern of vibrations that can enable him or her to avoid the obstacle. For example, if an obstacle is detected directly in front of the user and another obstacle is detected to the right of the user, the user can receive a specific vibration pattern on shoe 600L. The user identifies the vibration pattern as being indicative of the presence of obstacle and rotates to his or her left till the vibration stops (to indicate that the path is clear). In this manner, through vibrations a user can be navigated around obstacles.

In a second mode (known as perception mode), the user is alerted of the presence of an obstacle by varying the intensity of the vibration patterns. This gives the user a perception of how far he or she is from an obstacle. For example, if an obstacle is detected to the left of the user, the user receives a vibration on the shoe 600L wherein the intensity of the vibration increases as the user gets closer to the detected obstacle and decreases as the user moves away from the obstacle. In this way, the user gets a perception of the obstacles around him or her and can decide on how to avoid the detected obstacles. The perception mode may be preferred by users if they are moving around in known environments.

In some embodiments, shoes 600L and 600R can be used by a user to provide obstacle detection functionality operate without the need of being connected to or communicating with MU 102.

FIG. 6c illustrates an exemplary Wearable Interaction System 600B consistent with the disclosed embodiments. As shown in FIG. 6b, system 600B can include two shoes 600L (intended to be worn on the left foot) and 600R (intended to be worn on the right foot). Shoes 600L and 600R are similar in structure and functionality to shoe 600 discussed with respect to FIG. 6a. Furthermore, the navigation, orientation, and interaction functionality provided by shoes 600L and 600R of system 600B are similar to insoles 400L and 400R discussed with respect to FIGS. 4a-4d. 309

In addition to the above mentioned functionality, in some embodiments, system 600B can also be configured to detect one or more obstacles of different types and sizes that can hinder the safe passage of a user. In some embodiments, system 600B can be configured to detect one or more obstacles in a manner similar to that discussed with respect to ODU 223 in FIG. 3e.

Once an obstacle is detected by shoe 600L and/or 600R, the user can be alerted about the presence of an obstacle through a pattern of vibrations (different from direction and/or orientation information) and in a manner similar to that discussed with respect to FIG. 6b. Furthermore, in some embodiments, shoes 600L and 600R can be used by a user to provide obstacle detection functionality operate without the need of being connected to or communicating with MU 102.

FIG. 6d illustrates an exemplary Wearable Interaction System 600C consistent with the disclosed embodiments. As shown in FIG. 6d, system 600C can include two shoes 600L (intended to be worn on the left foot) and 600R (intended to be worn on the right foot). Shoes 600L and 600R are similar in structure and functionality to shoe 600 discussed with respect to FIG. 6a. Furthermore, the navigation, orientation, and interaction functionality provided by shoes 600L and 600R of system 600C are similar to insoles 400L and 400R discussed with respect to FIGS. 4a-4d.

In addition to the above mentioned functionality, in some embodiments, system 600C can also be configured to detect one or more obstacles of different types and sizes that can hinder the safe passage of a user. In some embodiments, system 600C can be configured to detect one or more obstacles in a manner similar to that discussed with respect to ODU 223 in FIGS. 3c and 3d.

Once an obstacle is detected by shoe 600L and/or 600R, the user can be alerted about the presence of an obstacle through a pattern of vibrations (different from direction and/or orientation information) and in a manner similar to that discussed with respect to FIG. 6b. Furthermore, in some embodiments, shoes 600L and 600R can be used by a user to provide obstacle detection functionality operate without the need of being connected to or communicating with MU 102.

FIG. 6e illustrates an exemplary Wearable Interaction System 600D consistent with the disclosed embodiments. As shown in FIG. 6e, system 600D can include two shoes 600L (intended to be worn on the left foot) and 600R (intended to be worn on the right foot). Shoes 600L and 600R are similar in structure and functionality to shoe 600 discussed with respect to FIG. 6a. Furthermore, the navigation, orientation, and interaction functionality provided by shoes 600L and 600R of system 600C are similar to insoles 400L and 400R discussed with respect to FIGS. 4a-4d.

In addition to the above mentioned functionality, in some embodiments, system 600D can also be configured to detect one or more obstacles of different types and sizes that can hinder the safe passage of a user. In some embodiments, system 600D can be configured to detect one or more obstacles in a manner similar to that discussed with respect to ODU 223 in FIG. 3b.

Once an obstacle is detected by shoe 600L and/or 600R, the user can be alerted about the presence of an obstacle through a pattern of vibrations (different from direction and/or orientation information) and in a manner similar to that discussed with respect to FIG. 6b. Furthermore, in some embodiments, shoes 600L and 600R can be used by a user to provide obstacle detection functionality operate without the need of being connected to or communicating with MU 102.

FIG. 6f illustrates an exemplary Wearable Interaction System 600E consistent with the disclosed embodiments. As shown in FIG. 6b, system 600E can include two shoes 600L (intended to be worn on the left foot) and 600R (intended to be worn on the right foot). Shoes 600L and 600R are similar in structure and functionality to shoe 600 discussed with respect to FIG. 6a. Furthermore, the navigation, orientation, and interaction functionality provided by shoes 600L and 600R of system 600E are similar to insoles 400L and 400R discussed with respect to FIGS. 4a-4d.

In addition to the above mentioned functionality, in some embodiments, system 600E can also be configured to detect one or more obstacles of different types and sizes that can hinder the safe passage of a user. In some embodiments, system 600E can be configured to detect one or more obstacles in a manner similar to that discussed with respect to ODU 223 in FIG. 3a.

Once an obstacle is detected by shoe 600L and/or 600R, the user can be alerted about the presence of an obstacle through a pattern of vibrations (different from direction and/or orientation information) and in a manner similar to that discussed with respect to FIG. 6b. Furthermore, in some embodiments, shoes 600L and 600R can be used by a user to provide obstacle detection functionality operate without the need of being connected to or communicating with MU 102.

As was discussed earlier, a user of insole 400 and/or shoes 500 or 600 can personalize several functions, operations, and/or gestures. FIGS. 7a and 7b are tables illustrating exemplary options that a user of haptic footwear such as shoes 600L and 600R can personalize. It should be understood that the various options shown in FIGS. 7a and 7b are exemplary and are not intended to be limiting.

Other embodiments will be apparent to those skilled in the art based on the disclosed embodiments. Various modifications may be made to the systems or methods in the disclosed embodiments. The specification and examples are exemplary only, with a true scope and spirit of the disclosure being indicated by the following claims.

What is claimed is:

1. A haptic feedback based shoe, the shoe comprising:
at least one microprocessor unit, the at least one microprocessor unit configured to control at least one operation of the shoe;
at least one battery, the at least one battery configured to provide a power supply voltage;
at least one Radio Frequency (RF) unit, the at least one RF unit configured to communicate with at least one external electronic device using at least one wireless communication protocol;
at least one vibration motor, the at least one vibration motor configured to generate at least one pattern of vibration; and
at least one inertial motion unit (IMU), the at least one IMU further including at least one magnetometer, the at least one magnetometer configured to provide at least one reading indicative of orientation.

2. The shoe of claim 1, further comprising:
at least one voltage regulator circuit coupled to the at least one battery and configured to supply an operating voltage to the at least one microprocessor unit;
at least one on/off switch coupled to the at least one voltage regulator circuit and configured to turn on and/or off the power supply to the at least one voltage regulator circuit; and
at least one charging circuit coupled to the at least one battery and configured to charge the at least one battery.

3. The shoe of claim 1, wherein at least one microprocessor unit is further coupled to at least one pressure sensor, the at least one pressure sensor is configured to provide at least one pressure reading indicative of a force exerted on the at least one pressure sensor.

4. The shoe of claim 3, wherein the at least one pressure sensor is configured to turn on and/or off the power supply to the at least one voltage regulator circuit.

5. The shoe of claim 1, wherein the at least one RF unit is configured to communicate with the at least one external device using a bluetooth communications protocol.

6. The shoe of claim 5, wherein the at least one external device is a mobile phone.

7. The shoe of claim 5, wherein the at least one external device is a game console.

8. The shoe of claim 5, wherein the at least one external device is another shoe.

9. The shoe of claim 1, wherein the inertial motion unit further includes at least one accelerometer.

10. The shoe of claim 1, wherein the inertial motion unit further includes at least one gyroscope.

11. The shoe of claim 9, wherein the at least one microprocessor unit is configured to detect at least one foot based gesture via the at least one inertial motion unit, further comprising:
receiving, by the at least one microprocessor unit at least one reading from the inertial motion unit; and
processing, by the at least one microprocessor unit the at least one reading, the processing by the at least one microprocessor including comparing the at least one reading with at least one calibrated reading.

12. A system for human computer interaction using a pair of haptic shoes, the system comprising:
at least one external device configured to communicate with a first shoe and a second shoe, the first shoe and the second shoe each including:
at least one microprocessor unit, the at least one microprocessor unit configured to control at least one operation of the shoe;
at least one battery, the at least one battery configured to provide a power supply voltage;
at least one Radio Frequency (RF) unit, the at least one RF unit configured to communicate with the at least one external device using at least one wireless communication protocol;
at least one vibration motor, the at least one vibration motor configured to generate at least one pattern of vibration;
at least one inertial motion unit (IMU), the at least one IMU further including at least one magnetometer, the at least one magnetometer configured to provide at least one reading indicative of orientation.

13. The system of claim 12, further configured to provide feedback indicative of direction, comprising:
providing a first vibration pattern on the first shoe, the first vibration pattern on the first shoe indicative of a right turn;
providing the first vibration pattern on the second shoe, the first vibration pattern on the second shoe indicative of a left turn;
providing a second vibration pattern on the first shoe, the second vibration pattern on the first shoe indicative of rotating towards the right; and
providing the second vibration pattern on the second shoe, the second vibration pattern on the second shoe indicative of rotating towards the left.

14. The system of claim 12, wherein the inertial motion unit in at least one of the first and second shoe further includes at least one accelerometer.

15. The system of claim 12, wherein the inertial motion unit in at least one of the first and second shoe further includes at least one gyroscope.

16. The system of claim 14, further configured to:
save at least one gesture performed by at least one of the first shoe and the second shoe.

17. The system of claim 14, further configured to:
recognize at least one saved gesture performed by at least one of the first shoe and the second shoe; and
control at least one operation of the at least one external device based on the at least one gesture recognized in the said recognize step.

18. A haptic feedback based shoe, the shoe comprising:
at least one microprocessor unit, the at least one microprocessor unit configured to control at least one operation of the shoe;
at least one battery, the at least one battery configured to provide a power supply voltage;
at least one Radio Frequency (RF) unit, the at least one RF unit configured to communicate with at least one external electronic device using at least one wireless communication protocol;
at least one vibration motor, the at least one vibration motor configured to generate at least one pattern of vibration;
at least one inertial motion unit (IMU), the at least one IMU further including at least one magnetometer, the at least one magnetometer configured to provide at least one reading indicative of orientation; and
at least one camera, the at least one camera configured to provide at least one image data to the at least one microprocessor unit, the at least one microprocessor unit further configured to detect at least one obstacle from the at least one image.

19. The shoe of claim 18, further comprising:
at least one sonar sensor, the at least one sonar sensor configured to provide a distance measure to at least one obstacle;

20. The shoe of claim 18, further comprising:
at least one structured light projector, the at least one structured light projector configured to project at least one light pattern; and
the at least one camera configured to capture at least one image including the at least one light pattern; and
the at least one microprocessor unit further configured to detect at least one obstacle by processing the at least one image.
